(19) United States
(12) Patent Application Publication
(10) Pub. No.: US 2026/0050690 A1
(43) Pub. Date: Feb. 19, 2026

(54) Trusted Execution Environment for a Measurement Platform

(71) Applicant: GOOGLE LLC, Mountain View, CA (US)

(72) Inventors: Chanda Patel, Mountain View, CA (US); John Tobler, Mountain View, CA (US); Quaseer Mujawar, Palo Alto, CA (US)

(21) Appl. No.: 18/907,066

(22) Filed: Oct. 4, 2024

Related U.S. Application Data
(60) Provisional application No. 63/684,289, filed on Aug. 16, 2024.

(51) Int. Cl. G06F 21/62; G06F 21/60; G06Q 30/0251

(52) U.S. Cl. CPC G06F 21/6263; G06F 21/602; G06Q 30/0269

(57) ABSTRACT

One or more servers send, to a user device executing a software application, a tagging snippet to be provided in the software application along with a content software application requested from a content provider and auxiliary content the software application received from an auxiliary content provider. The tagging snippet, in response to a user interacting with the auxiliary content via the software application, causes the software application to: (i) obtain a public key, (ii) encrypt, using the public key, personally identifiable information associated with the user, and (iii) send the encrypted personally identifiable information to a collection endpoint associated with a trusted execution environment (TEE) implemented in a cloud computing platform.

### CROSS-REFERENCE TO RELATED APPLICATION

This application claims priority to and the benefit of the filing date of provisional U.S. Patent Application No. 63/684,289 entitled “Trusted Execution Environment for a Measurement Platform,” filed on Aug. 16, 2024. The entire content of the provisional application is hereby expressly incorporated herein by reference.

### FIELD OF THE DISCLOSURE

This disclosure relates to a secure computing environment and, more particularly, to techniques for improving the security and privacy of using Trusted Execution Environments (TEEs) for operations on private and/or sensitive data, implemented in a cloud or another suitable environment.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Cloud computing is a network-based computing technique in which typically large groups of servers housed in data centers or “server farms” provide computational resources and data storage to remote end users. As the number of workflows utilizing first-party (1P) data in the cloud grows, new trust, privacy, and security paradigms are being considered to advance the guarantees given to data owners. These include using Trusted Execution Environments (TEEs), such as enclaves, confidential computing, and Secure Multi-Party Computation (MPC). Traditionally, the TEEs were created to support stand-alone computers and mobile devices to provide secure execution in the isolated trusted firmware based environments. In a public cloud, however, the traditional TEE technologies are inadequate.

An example technology that requires confidential computing is software that measures the impact of content on users. As a more specific example, recent changes in the digital advertising landscape have created new challenges for providers of advertising measurement tools. The challenges include reducing signal loss, addressing privacy concerns, and meeting advertiser demands. Today, client or customer data, which is an example of 1P data, may contain sensitive data such as Personally Identifiable Information (PII) which is subject to regulations, customer policies, and platform restrictions. Examples of PII include email addresses, home addresses, names, and phone numbers. Moreover, many customers of providers of advertising measurement tools do not wish to share PII data without certain assurances regarding access and usage.

Cloud-based TEE architectures generally anchor their security and privacy properties on both technology and trusting people, such as owners of accounts that hold decryption keys. According to one example approach, trust is increased by distributing secure information among multiple parties so that multiple stakeholders would need to violate their terms of service and collude to extract data which they are not authorized to access. Security for such architectures is based on the audit-attestation model. The technical mechanisms that make this security possible are the infrastructure for enclave attestation and conditional cryptographic operations, e.g., where certain keys can only be used from TEEs having a certain known hash.

Although these techniques generally increase security and protection privacy, it is desirable to provide stronger protection of private information, particularly PII, at all stages of generation, transmission, and processing.

### SUMMARY

An example embodiment of these techniques is a method implemented in one or more servers. The method comprises sending, to a user device executing a software application, a tagging snippet to be provided in the software application along with a content software application requested from a content provider and auxiliary content the software application received from an auxiliary content provider. The tagging snippet, in response to a user interacting with the auxiliary content via the software application, causes the software application to (i) obtain a public key, (ii) encrypt, using the public key, personally identifiable information associated with the user, and (iii) send the encrypted personally identifiable information to a collection endpoint associated with a trusted execution environment (TEE) implemented in a cloud computing platform.

Another example embodiment of these techniques is a method implemented in a plurality of servers. The method includes receiving, at a cloud staging layer implemented in a cluster manager, encrypted personally identifiable information for a plurality of users; transmitting, to a TEE via a collection endpoint in a cloud computing platform, the encrypted personally identifiable information; decrypting, within the TEE, the personally identifiable information using a private key; and processing, within the TEE, the decrypted personally identifiable information.

Still another example embodiment of these techniques is a method implemented in a software layer executing on a cloud computing platform. The method comprises receiving, at a trusted execution environment (TEE) from a collection endpoint, encrypted personally identifiable information for a plurality of users; obtaining a first portion of a private key from a first coordinator; obtaining a second portion of the private key from a second coordinator operating independently of the first coordinator; decrypting, within the TEE, the personally identifiable information using the private key; and processing, within the TEE, the decrypted personally identifiable information.

Yet another example embodiment of these techniques is a cloud computing platform comprising a set of servers and configured to implement one of the methods above.

### BRIEF DESCRIPTION OF THE DRAWINGS

FIG. 1A is a block diagram of an example computing environment in which a cloud platform performs, within a TEE, confidential matching, attribution, and aggregation on end-to-end encrypted sensitive data;

FIG. 1B is a block diagram of an example computing environment generally similar to that of FIG. 1A, but in which the cloud platform performs PII redaction on mapping within the TEE;

FIG. 1C is a block diagram of an example computing environment generally similar to that of FIG. 1A, but in which an external key manager splits ownership of a private key between the cloud platform and a third party;

FIG. 2A is a diagram of an example data path for mapping PII to account identifiers (IDs), which can be implemented in the environment of FIG. 1B;

FIG. 2B is a diagram of an example data path for mapping PII to click IDs, which can be implemented in the environment of FIG. 1B;

FIG. 2C is a diagram of an example data path for mapping PII to pseudo IDs associated with the cloud platform, which can be implemented in the environment of FIG. 1B;

FIG. 3 is a diagram of an example data path for mapping PII to account identifiers (IDs) associated with the cloud platform, which can be implemented in the environment of FIG. 1A or 1C;

FIG. 4A is a diagram of synchronous client requests to a confidential processing logic in a TEE, which can be implemented in the environment of FIGS. 1A-C;

FIG. 4B is a diagram of asynchronous client requests to a confidential processing logic in a TEE, which can be implemented in the environment of FIGS. 1A-C;

FIG. 5 is a flow diagram of an example method for reporting PII data, which can be implemented in a software routine executable in a web browser; and

FIG. 6 is a flow diagram of an example method for confidential processing of PII data, which can be implemented in a TEE.

### DETAILED DESCRIPTION OF THE DRAWINGS

Generally speaking, a software layer executing on a cloud computing platform implements privacy enhancing techniques to allow client services to operate on datasets related to customers of the client services, without exposing private customer data to the cloud computing platform. The software layer performs such operations as confidential matching, attribution, aggregation, etc. on end-to-end encrypted data in a Trusted Execution Environment (TEE). In this manner, a client service can perform for example a matching and measurement operation, while the cloud computing platform only detects matches between units of data and remains effectively blind to the actual information on which the client service operates. Client services can similarly collaborate without sharing confidential information within the TEE of the cloud computing platform.

The client services, or simply “clients,” can be for example, providers of digital advertisements, and the operations these clients perform on the datasets are measurements of how effectively the digital advertisements perform. Using the techniques discussed below, a software layer operating on a cloud computing platform processes sensitive data in a secure environment and allows customers to control the flow and usage of their data. As a result, the software layer on a cloud computing platform can provide certain privacy and security guarantees.

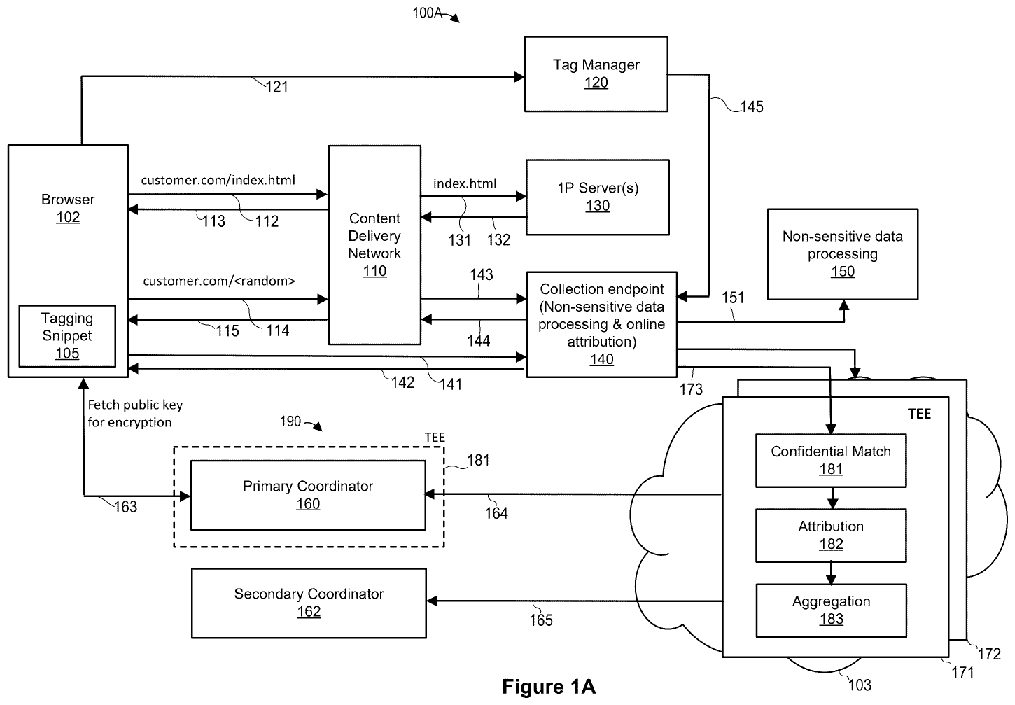

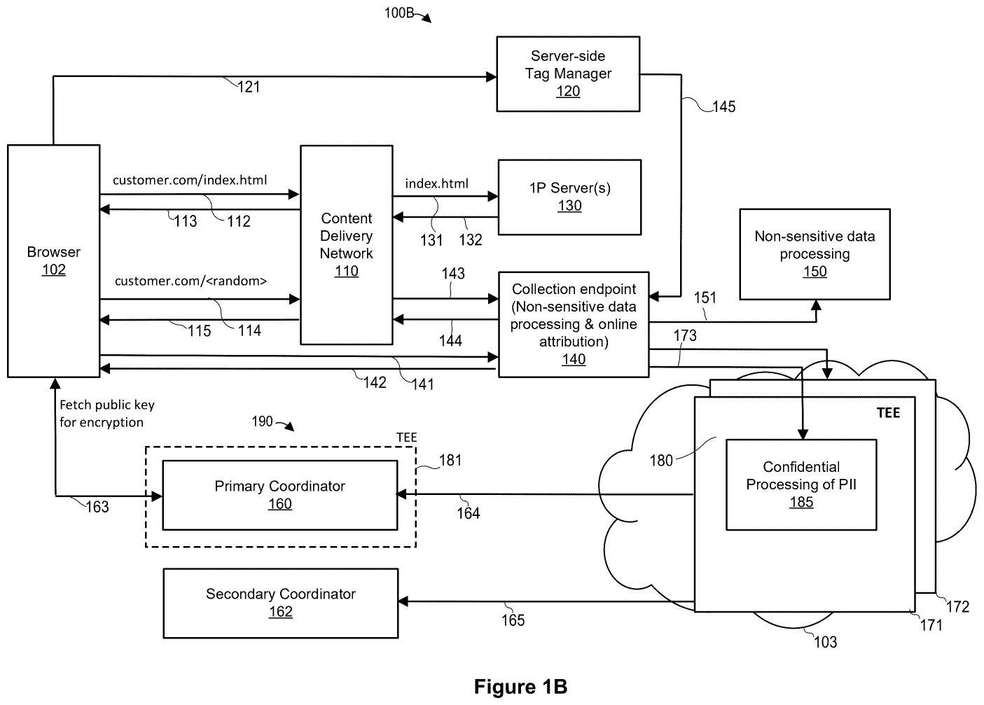

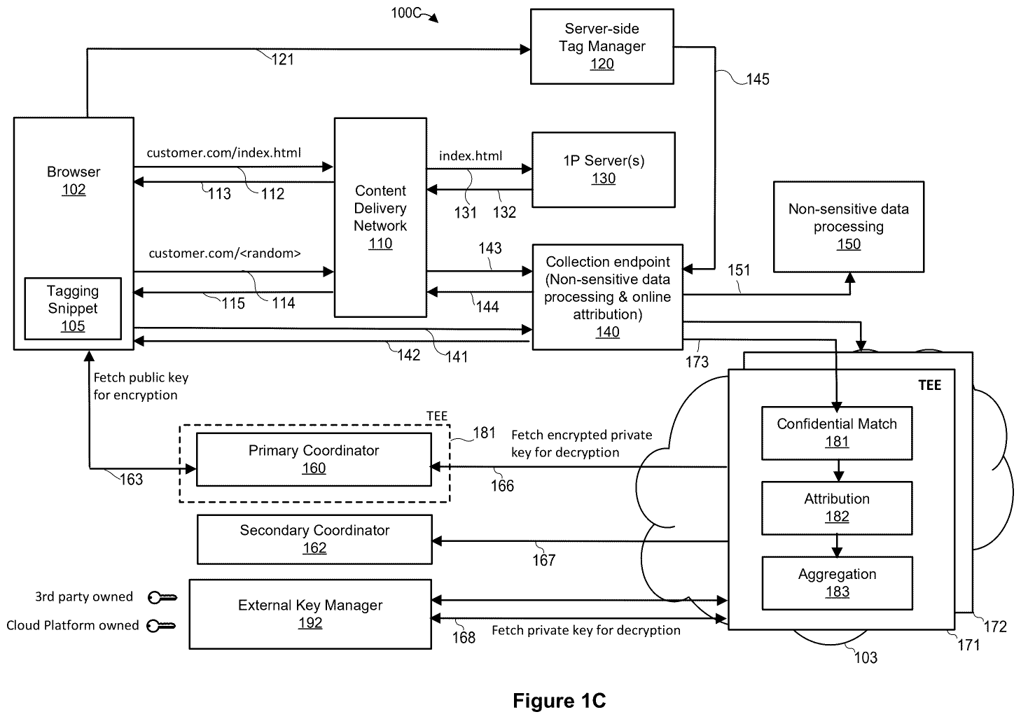

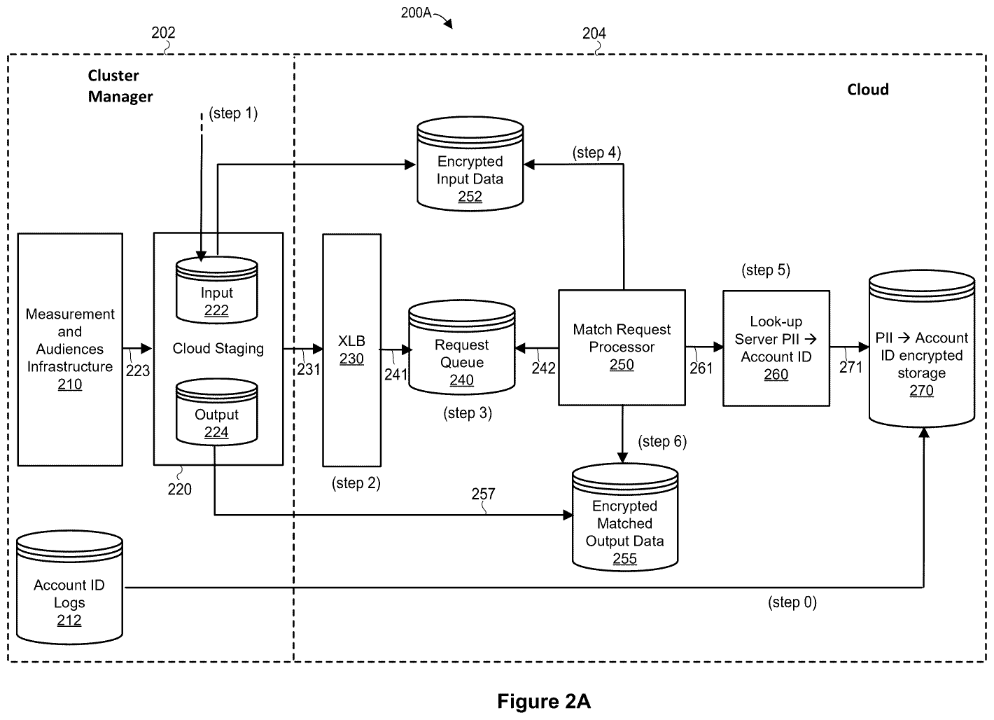

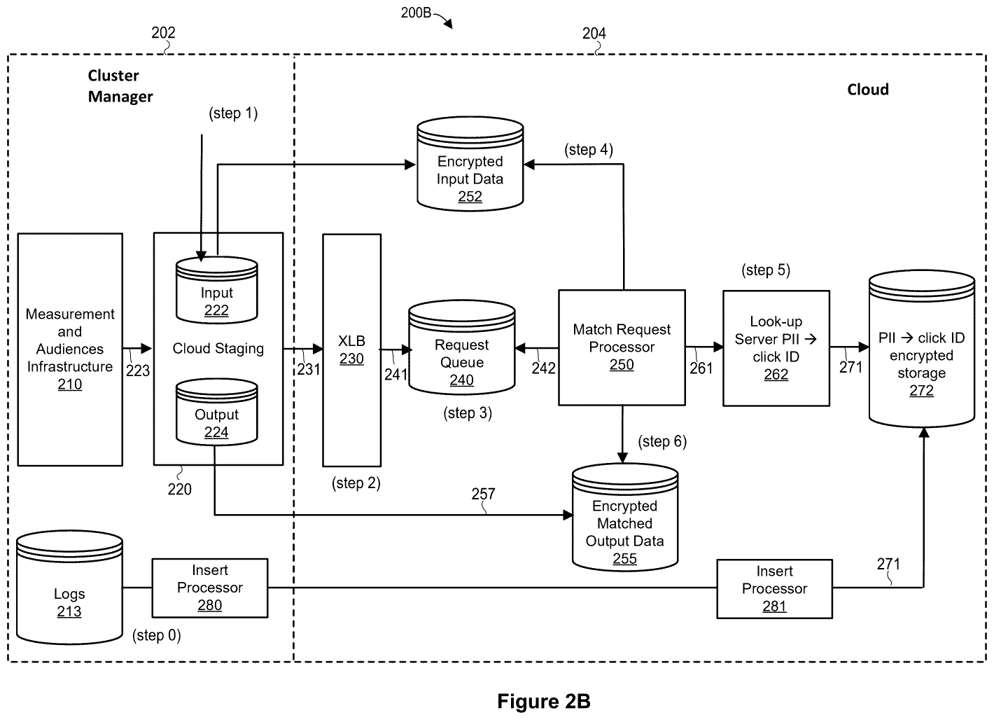

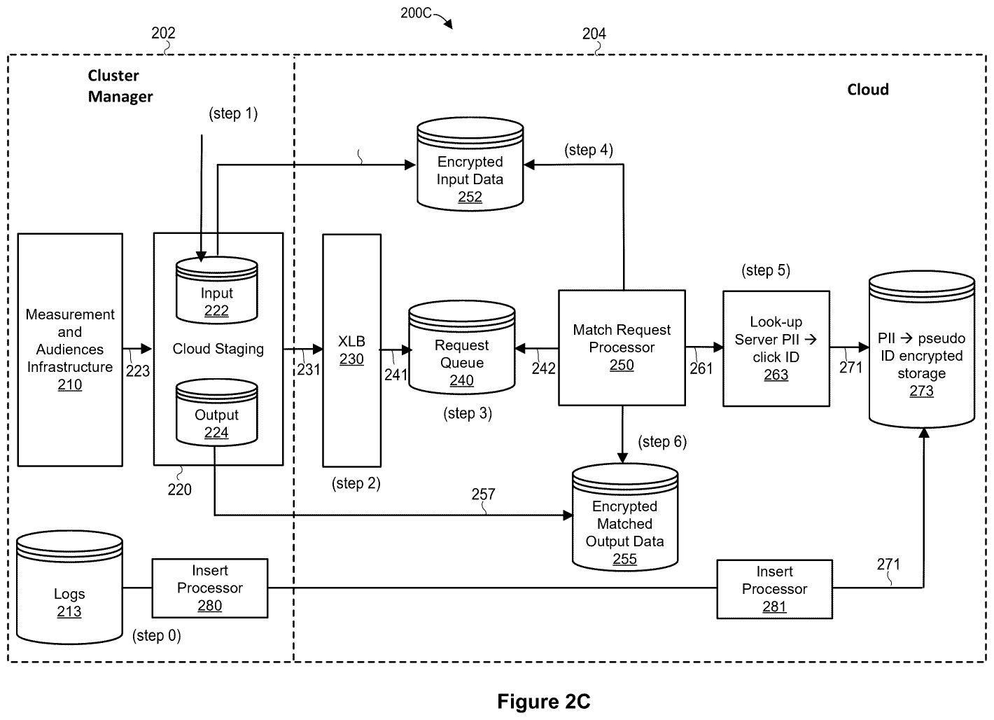

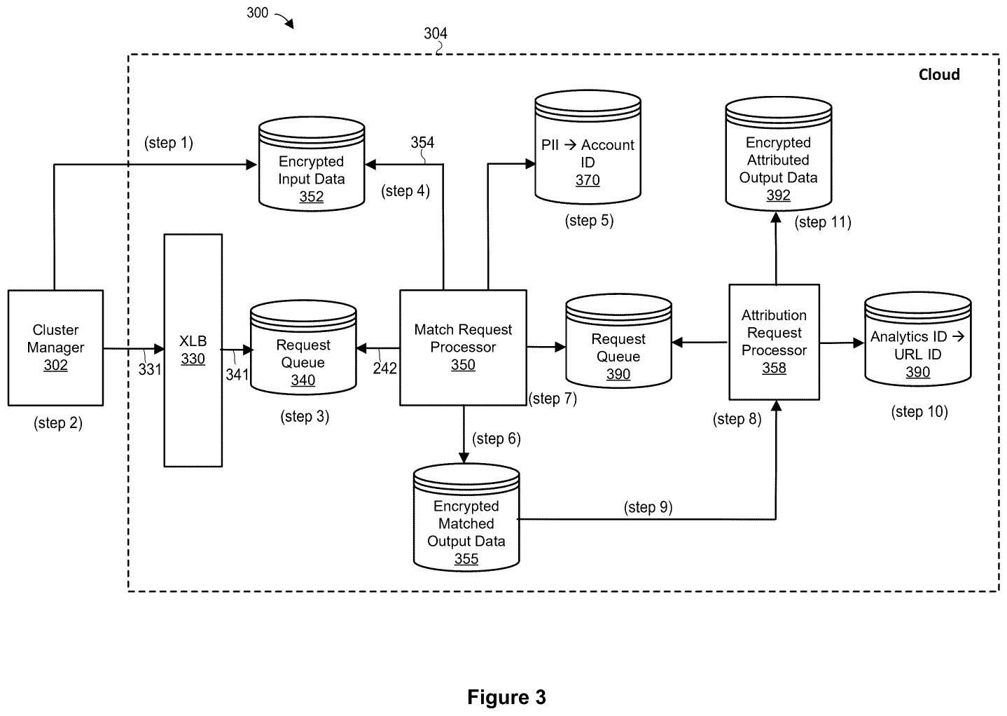

Several example implementations of a cloud platform, and a software layer executing on the platform, that can perform these operations are discussed with reference to FIGS. 1A-C, followed by a discussion of example data flows with reference to FIGS. 2A-3.

Referring first to FIG. 1A, in an example system 100A, a cloud computing platform (or simply “cloud” or “cloud platform”) 103 provides a trusted execution environment for operations on secure datasets. A user can operate a software application such as a browser 102 to access websites, make purchases, view ads, etc. In particular, the browser 102 can send 112 a request to a content delivery network (CDN) 110. In addition to the primary content, the CDN 110 can request 131 and receive 132 auxiliary content from a first-party (“1P”) server 130. The CDN 110 can provide 113 the auxiliary content along with the primary request content to the browser 102. The browser 102 further transmits 114 certain non-personal (and, in some cases, encrypted personal) data to the CDN 110 and receives 115 a corresponding response. The CDN 110 can forward 143 the non-personal data (and personal data) to a collection endpoint 140 and receive 144 a corresponding confirmation.

The cloud 103 can include any suitable number of servers and storage devices to provide cloud computing and storage functionality to client systems via a computer network. The browser 102 can operate on any suitable computing device equipped with one or more processors and a memory. Although the example systems, data flows, and methods are discussed below with reference to the browser 102, in general the techniques discussed with reference to browser 102 can be implemented in any suitable application such a video streaming application, an email application, a gaming application, etc.

The first-party server 130 can operate on any suitable platform (e.g., one or more servers) and can for example provide digital advertisements for a certain advertiser. In addition to sending digital advertisements to various users via their respective browsers or other software applications such as games, video players, audio players, etc., the advertiser can use certain advertising technology, or software for buying, managing, and analyzing digital advertisement. To protect the privacy of the user operating the browser 102, the software layer implemented in the cloud 103 implements, in a TEE 171, such functions as confidential matching (e.g., matching certain activity by an anonymized user associated with certain PII1 to another activity of the same anonymized user with PII2), attribution of activity to a certain user, service, campaign, etc., or aggregation of datasets.

The browser 102 encrypts sensitive data (e.g., personal data, particularly PII), so that only the attested infrastructure that implements the TEE 171 can decrypt the data for processing. More specifically, the browser 102 can use a tagging snippet 105 to encrypt sensitive data prior to sending the sensitive data to the collection endpoint 140. To this end, the browser 102 can receive the tagging snippet (code) 105 from the tag manager 120. Thus, in the system of FIG. 1A, the TEE 171 operates on data encrypted at the source.

In another implementation or scenario, and as discussed further below, the CDN 110 rather than the browser 102 sends the encrypted data to the collection endpoint 140. In yet another implementation, the frontend TEE sends the encrypted data to the collection endpoint 140. The transmission can be an HTTP request that includes the PII and, in some implementation, also the conversion data.

In one implementation, the tag manager 120 provides a client-side tagging snippet that transmits 141 the encrypted PII directly to the collection endpoint 140 and receives 142 a corresponding confirmation. In another implementation, the tag manager 120 implements server-side tagging snippet. As a more specific example, the tag manager 120 can be the server-side Google Tag Manager (SGTM). In this case, the tag manager 120 executes some of the tagging code, and the tagging snippet 105 provides the encrypted PII to the collection endpoint 140 via the tag manager 120. In particular, the tagging snippet 105 provides 121 the encrypted PII to the tag manager 120, which in turn provides 145 the encrypted PII to the collection endpoint 140.

To encrypt sensitive data, the browser 102 can fetch 163 a public encryption key from a primary coordinator 160, discussed in more detail below. In another implementation, the browser 102 obtains the public encryption key from a party associated with the 1P server 130.

With continued reference to FIG. 1A, the collection endpoint 140 can send 151 non-sensitive data to a non-sensitive data processing stage 150. However, the collection endpoint 140 sends 173 the encrypted PII to the TEE 171 implemented in the cloud 103. The measurement infrastructure in these examples does not have the ability to decrypt or process the data and instead routes the encrypted data to the collection endpoint 140 and eventually to the TEE 171 for processing.

A TEE 171 includes a confidential match module 181, an attribution module 182, and an aggregation module 183. Generally speaking: the confidential match module 181 is configured to implement one or more matching algorithms for finding correspondences or relationships within datasets; the attribution module 182 is configured to link events back to their likely causes; and aggregation module 183 is configured to calculate summaries or statistics based on the raw data. The TEE 171 can include hardware and software that implements a secure environment by allowing code to execute in isolation and protect data within the TEE 171 from external access. Further, the TEE 171 in some scenarios allows external parties to verify that the software operates in exact conformance to the claims of the software manufacturer.

One or more of the modules 181, 182, and 183 can fetch 164, 165 the private key for decryption from the primary coordinator 160 and a secondary coordinator 162. More particularly, the TEE 171 can fetch 164 a first component of the private key from the primary coordinator 160, and fetch 165 a second component of the private key from the secondary coordinator 162. The primary coordinator 160 in some cases operates in a TEE 181, which can be a part of the TEE 171 or a separate TEE. Generally speaking, a coordinator is a trusted party that holds sensitive data in a way that any human operator could only partially access obfuscated partial sensitive information, and multiple parties need to collude in order to retrieve data in an authorized manner. The coordinator can perform such functions as auditing open-source codebases, verifying the hash of a binary image against the hash obtained from the product of the codebase, managing the global service deployments in a cloud, etc. In an example scenario, the coordinator 160 is associated with the software layer 103 implemented on a cloud platform, and the coordinator 162 is associated with a third party.

The software layer 103 can limit the ability to decrypt the PII (i.e., to gain access to the appropriate private key) to only those services running in the TEE 171 that have a specific binary hash. The coordinator 160 and/or the coordinator 162 specify the policy for accessing the private key, in some implementations.

The coordinators 160, 162 operate in this implementation as a part of the key management service (KMS) 190, which enables verifiable decryption at the TEE 171. The KMS 190 generates an asymmetric key pair including a public key, which the KMS 190 distributes openly, and a private key, which the KMS 190 splits between the coordinators 160 and 162 in a secure manner. For example, the KMS 190 can implement the technique known as Shamir's secret sharing (SSS), which is based on splitting secret information into multiple shares that individually do not give sufficient information about the secret information to any individual holder of a share. The KMS 190 can guarantee the security of this process through remote attestation of binaries and secure communication channels, for example.

With continued reference to FIG. 1A, the software layer 103 can implement separate TEEs 171, 172 for different geographic regions, different types of services, etc. Depending on the implementation, multiple TEEs can rely on the same coordinators or different coordinators for the key management service.

In the implementation of FIG. 1A, the confidential match module 181 provides the matched data to the attribution module 182 and then to the aggregation module 183. The TEE 171 here provides anonymity and aggregation for a particular data path. For example, the data path corresponding to the modules 181, 182, and 183 can implement conversion measurement to assess the efficacy of including advertisements in web content. More particularly, an advertiser may wish to track conversion events that occur on a web page, such as initiating a purchase. As another example, the data path corresponding to the modules 181, 182, and 183 can implement conversion measurement to assess the efficacy of offline transactions from a website lead or a visitor.

In the implementation of FIG. 1A, the modules 181, 182, and 183 are special-purpose modules that can perform conversion measurement including attribution and de-identification of data, and then send the results of this analysis to the cluster manager (see FIGS. 2A-C), i.e., outside the TEE 171, for various analytics.

On the other hand, an example system 100B illustrated in FIG. 1B includes a confidential processing of PII module 185 configured to perform a wider range of operations on PII. The operations can be related to attribution, audience reporting (demographics, segments, etc.), and any other suitable measurements.

For example, the module 185 can process PII for conversions for web, to allow accurate conversion measurement when cookies restrictions are in place. This type of tracking can be used when a conversion tag generates encrypted PII an advertiser collects on its conversion page (e.g. email addresses), and the software layer 103 matches the hashed customer data against log-in information the user provided to one or more online services associated with a provider of the software layer 103 (e.g., email, file sharing, video hosting). As another example, the module 185 can process PII for conversions for leads. In this case, a marketer can send conversions keyed by the encrypted PII to match with the lead submission. As yet another example, the module 185 can operate on a user identifier (UID) which can be a SHA256-hashed version of an email address, a phone number, or a mailing address for the analytics services associated with the provider of the software layer 103.

If desired, the implementation illustrated in FIG. 1B can provide the following technical guarantees to a customer. According to one technical guarantee, only verified code running inside the TEE 171 can access and decrypt PII. The code that processes the PII is verified, attested and open sourced. According to another technical guarantee, for specific use cases, such as conversion measurement in which the PII should be already known to the software layer 103 (e.g., login information with which a user logs into an online service associated with the provider of the software layer 103), the software layer 103 neither obtains new PII for the existing users nor acquires PII for the non-users. The module 185 can for example redact the non-qualifying PII. According to another technical guarantee, the software layer 103 does not access or exfiltrate non-encrypted PII or apply the encryption keys for purposes other than the processing at the module185 within the TEE 171. Still another technical guarantee can be the regionalization of sensitive data, e.g., processing certain data within the TEE 171 and processing another data within the TEE 172. Still further, the software layer 103 can ensure that the decrypted PII does not leave the TEE 171, to prevent learning the TII from other use cases.

Referring to FIGS. 1A and 1B, the private key the TEE 171 fetches for decryption, and the associated public key the browser 102 uses for encryption, can belong to a coordinator (e.g., the coordinator 160) or the customer that requests operations on the datasets on the software layer 103.

For example, the private key can belong, and remain under the control of, an advertiser that operates the 1P server to provide auxiliary content to browser 102 via the CDN 110. In this manner, the advertiser can exercise more control over the code that processes PII in the datasets of the advertiser. This approach provides the additional technical advantage of allowing the advertiser to use the same mechanism for online as well as for offline conversion import flows. On the other hand, when a coordinator controls the private key, the software layer 103 requires different configurations for online and offline import flows.

Referring to FIG. 1C, a system 100C is similar to the system 100A of FIG. 1A, but here a third party operates an external key manager 192. The TEE 171 can fetch 168, from the external key manager 192, a private key for decryption. The private key can include a component owned by the software layer 103 and a component owned by another third party. In an example implementation, the third party that controls the component of the private key is associated with the secondary coordinator 162. Unlike the system of FIG. 1A or FIG. 1B, here the TEE 171 can fetch 166, 167 an encrypted (rather than unencrypted) private key from the coordinators 160 and 162.

As discussed above, the encryption of PII can occur at the browser 102. This approach provides the technical advantage of encrypting PII at the source, but also is associated with the risk that the tag manager 120 (which in some implementations can be associated with the operator of the software layer 103) provides a tagging snippet that retrieves the encryption key from the wrong source or otherwise performs incorrectly. Accordingly, in one implementation, the tagging snippet is provided in the form of open-source code, so that the logic of encrypting PII with a public key can be verified. In another implementation, the tagging snippet is automatically validated. In yet another implementation, the tag manager 120 obtains the tagging snippet from the 1P server 130 or otherwise from the first party. In this manner, the first party that relies on the PII processing within the TEE 171 also provides the code for encryption at the browser 102 (and/or the public key).

In another implementation, the CDN 110 encrypts the PII data. However, this approach would require compliance from the CDN 110 as well as trust in the CDN 110. In yet another implementation, the TEE frontend encrypts the PII data. This approach would require, however, that the client validate the connection to the TEE frontend. Moreover, similar to the example above, there is a risk that the tagging snippet connects to the wrong collection endpoint.

Several example data paths with PII matching are considered next with reference to FIGS. 2A-C. The system 100B discussed above can support these data paths to match PII.

First, matching PII to an account ID is discussed with reference FIG. 2A. In this example, a cloud platform 204, which can be implemented similar to the software layer 103 discussed above, can provide certain online services such as search, video sharing, photo sharing, email, messaging, geographic maps, etc. These online services can support a logged-in mode of operation, for which a user can have a certain account ID. As a more specific example, the account ID can be a Google Accounts and ID Administration (GAIA) ID. The data path 200A of FIG. 2A can apply when the TEE 171 analyzes conversions for web, for example.

More specifically, using the data path 200A, a client or customer (e.g., the operator of the 1P server 130) can provide encrypted data including PII to the cloud platform 204, which decrypts the PII using attestation, matches the PII to PII associated with the online services, and returns only the PII known to the online services.

As illustrated in FIG. 2A, the data path 200A includes a stage associated with a cluster manager 202 and a stage associated with the cloud platform 204. The cluster manager 202 in general can run a large number of jobs associated with numerous applications. The cluster manager 202 can utilize one or more clusters, each including any suitable number of (e.g., 100, 1000, 10000) machines. The cluster manager 202 can implement admission control and quota checking, grouping identical tasks into jobs, machine sharing, process-level performance isolation, etc.

The cluster manager 202 can host a measurement and audiences infrastructure 210, which does not have the ability to decrypt or process the data. The measurement and audiences infrastructure 210 can route 223, 231 encrypted data to a suitable collection endpoint (see FIG. 1B) for processing. To simplify the process of invoking the functionality in a TEE (e.g., the functionality of module 185 in FIG. 1B), the cluster manager 202 can implement a cloud staging layer 220. This layer operates as a bridge between the cluster manager 202 and the cloud platform 204. The cloud staging layer 220 can support API calls for clients to submit encrypted data and retrieve output such as match data from the cloud platform 204. Further, the cloud staging layer can make the responses available in a format acceptable to the client. Thus, the cloud staging layer 220 can implement data preparation for a TEE and result processing from the TEE.

At step 0, the cloud platform 204 fetches PII/account ID data from an account ID log database 212 into the TEE of the cloud platform 204. The PII/account ID data in the database 212 can be associated with one or more of the online services discussed above. In some implementations, the same party operates the online services and the cloud platform 204. In other implementations, however, the parties that operate the online services and the cloud platform 204 can be separate. The provider of the online services refreshes the account ID log database 212 according to a certain schedule to ensure the accuracy of matching the data.

At step 1, the client submits encrypted data to an input bucket 222 of the cloud staging layer 220. At step 2, the client submits a request to initiate confidential processing, and the cloud staging layer 220 transfers 231 the client data to an external load balancer (XLB) 230, which operates in the cloud platform 204. The XLB 230 adds 241 the request to a request queue 240. At step 3, a match request processor 250 retrieves 242 the request or task from the request queue 240.

The match request processor 250 next retrieves 354 the encrypted input data 252 from the input bucket 222 of the cloud staging layer 220 (step 4). The match request processor 250 provides 261 the encrypted input data 252 to a look-up server 260 for PII-to-account-ID matching. At step 5, the look-up server 260 operates 271 on a PII-to-account-ID storage 270, and the match request processor 250 outputs, at step 6, encrypted matched output data into an encrypted matched output data storage 255. The cloud staging layer 220 can retrieve 257 the encrypted matched output data storage 255, process and format this data, and place the output in an output bucket 224. The client can retrieve data from the output bucket 224 using an appropriate API. The match request processor 250, the look-up server 260, and the storage 270 can be implemented in a TEE such as the TEE 171 discussed above.

In addition to the APIs for adding data to the input bucket 222 and retrieving data from the output bucket 224, to cloud staging layer 220 can provide APIs to initiate the processing, obtaining the status of the processing or another job, etc.

Next, matching PII to a click ID is discussed with reference to FIG. 2B. The click ID can be associated with a particular click event. For example, when a user interacts with certain auxiliary content (e.g., clicks on a digital advertisement), the browser 102 can generate a click ID, include the click ID in the Uniform Resource Locator (URL) of the landing page associated with the 1P server 130, i.e., the party that provided the auxiliary content. In other words, the browser 102 can append the click ID to a request to access a website with auxiliary content. As a more specific example, the click ID can be a Google Click Identifier (GCLID) or Microsoft Click ID (MSCLKID). The PII-to-click-ID mapping can be used to analyze conversion for leads.

Referring back to FIG. 1B for example, the tag manager 120 can generate a tagging snippet for the website associated with the 1P server 130, e.g., the landing page of the advertiser or another web site of the advertiser. For the data path 200B, the tagging snippet encrypts (and not merely hashes) the PII. The browser 102 or the tag manager 120 then sends the encrypted PII data to the collection endpoint 140.

Referring again to FIG. 2B, the TEE infrastructure on the cloud platform 204 can maintain the mapping of the PII-to-click-ID in a database 272 for example. During the offline conversion import flow, the advertiser can submit the encrypted PII to the cloud platform 204 via the cloud staging layer 220. The cloud platform 204 can return the corresponding click IDs without revealing the PII. The PII outside of the TEE always remains encrypted in this scenario.

The data path 200B is generally similar to the data path 200A of FIG. 2A, with the differences discussed below. At step 0, the cluster manager 202 sends the encrypted PII/click ID data from a logs database 213 into the TEE via an insert processor 280 operating in the cluster manager 202 and an insert processor 281 operating in the TEE of cloud platform 204. Unlike the look-up server 260 of FIG. 2A, a look-up server 262 of FIG. 2B matches PII with click IDs, and a TEE storage (e.g., database 272) stores encrypted PII-to-click-ID data.

In some implementations, the data path 200B can be set up for batch processing. A client can send a batch of encrypted PII to receive the corresponding click IDs as output.

Next, matching PII to a pseudo ID is discussed with reference to FIG. 2C. A pseudo ID can identify events generated for a certain user. In some implementations, the pseudo ID is associated with a 1P cookie. Generally speaking, the pseudo ID can replace user login data and operate as a pseudonym that protects the true identity of the user. In some systems, for a certain type of identity the measurement infrastructure maintains a mapping of some-ID-to-pseudo-ID, and then uses the pseudo ID in the rest of the system for processing. The purpose is to prevent matching across IDs in different namespaces. To make the matching service more secure and provable, the data path 200C moves the matching to pseudo ID into the cloud platform 204, which can guarantee that the PII does not leave the TEE at any time, and that no other services have access to the PII.

The data path 200C is generally similar to the data path 200A of FIG. 2B, but, unlike the look-up server 262 of FIG. 2B, a look-up server 263 of FIG. 2C matches PII with pseudo IDs, and a TEE storage 273 stores encrypted PII-to-pseudo-ID data.

Next, FIG. 3 illustrates a data path 300, which the system of FIG. 1A or 1C can support. In this example, the data path 300 operates to matching PII to account IDs, similar to the data path 200A of FIG. 2A.

At step 1, the client submits encrypted data to an input bucket of the cloud staging layer implemented in a cluster manager 302, which can be generally similar to the cluster manager 202. At step 2, the client submits a request to initiate confidential processing, and the cloud staging layer in the cluster manager 302 transfers 331 the client data to an XLB 330, which operates in the cloud platform 304. The XLB 230 adds 341 the request to a request queue 340. At step 3, a match request processor 350 retrieves the request or task from the request queue 340.

At step 4, the match request processor 350 retrieves the encrypted data 352 from the cloud staging layer of the cluster manager 302. The match request processor 350 further executes a PII look-up to generate a PII-to-account-ID match data 370 (step 5). Then, the match request processor 350 outputs, at step 6, encrypted matched output data into an encrypted matched output data storage 355.

The match request processor 350 then queues the request for the next stage (step 7) by adding the request to a request queue 390. At step 8, an attribution request processor 358 retrieves the request from the request queue 390 and performs attribution by executing an account ID look-up (step 10) and outputs encrypted attributed output data 392 (step 11).

The system of FIGS. 1A and 1B can process synchronous and/or asynchronous requests to support the data path 300.

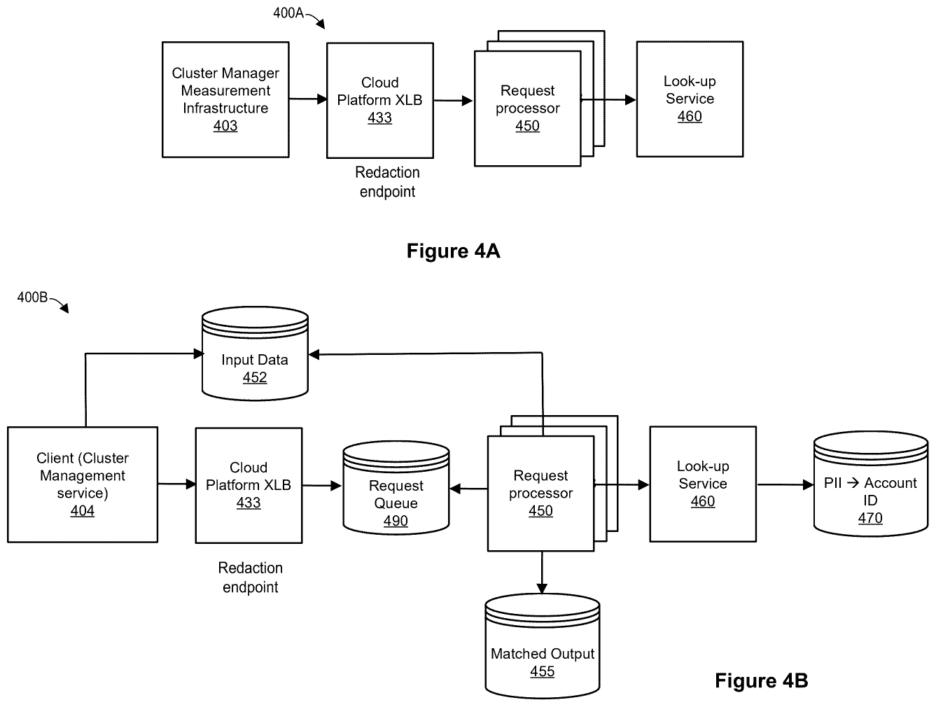

More particularly, FIG. 4A illustrates a scenario 400A in which a measurement infrastructure 403 implemented in a cluster management perform synchronous requests by accessing a cloud platform XLB 433, which then forwards the requests to the request processor 450. The cloud platform XLB 433 can operate as the cloud endpoint for redaction, for example. The request processor 450 retrieves requests from a request queue 390 and processes the requests using a look-up service 460 to generate a PII-to-account-ID data 470. Thus, according to this approach, the cluster manager submits a synchronous request to a cloud endpoint and returns the matched PII as a part of the response.

On the other hand, FIG. 4B illustrates a scenario 400B that includes asynchronous client requests to a confidential processing logic in a TEE. According to this approach, a client measurement service 404 operating in a cluster manager uploads data 452 to an input bucket, invokes an appropriate API to submit a to the platform XLB 433. In some scenarios, the client polls the platform XLB 433 to determine the status of the job or register an endpoint to be invoked when the job finishes. The match request processor 450 can provide the matched output 455 to a bucket in a cloud staging layer for example.

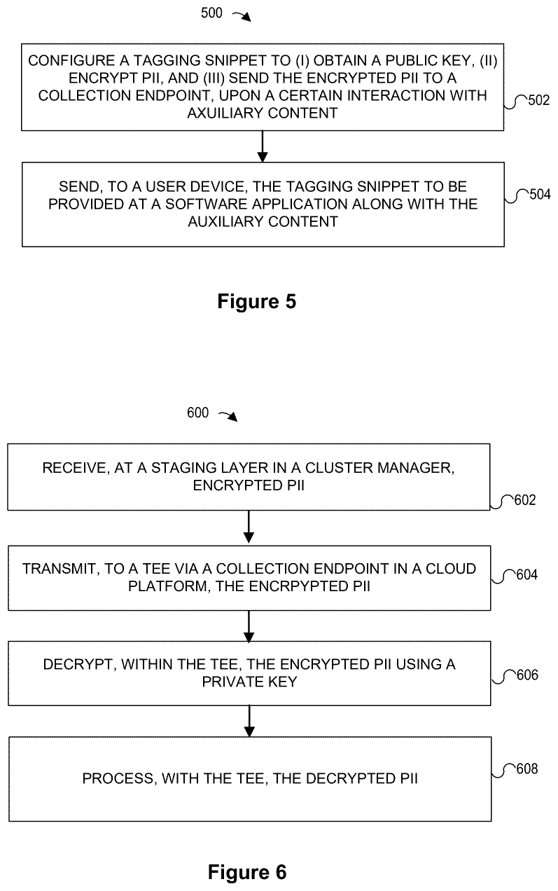

FIG. 5 is a flow diagram of an example method 500 for reporting PII data, which can be implemented in a software routine executable in a software application such as the web browser 102. At block 502, a tagging snippet is configured to obtain a public key, encrypt PII, and the send the encrypted PII to a collection endpoint, when the user interacts with auxiliary content (e.g., advertisement) in a certain manner. At block 504, the tagging snippet is sent to the user device, along with the auxiliary content. In general, the tagging snippet can be transmitted in the same message or in different message.

FIG. 6 is a flow diagram of an example method 600 for confidential processing of PII data, which can be implemented in a group of servers that implement a cluster manager and a cloud computing platform. At block 602, a cloud staging layer implemented in a cluster manager receives encrypted PII. Next, at block 604, the cloud staging layer can transmit the encrypted PII to a collection endpoint of a cloud computing platform, which then provides the encrypted PII to a TEE. As discussed above, the cloud staging layer can transmit the encrypted PII in response to a client invoking an API to request that the processing of the encrypted PII be initiated. At block 606, the TEE obtains the private key and decrypts the encrypted PII data. At block 608, the TEE processes the decrypted PII. The processing can include confidential data matching, attribution, aggregation, etc.

The following list of examples reflects a variety of the embodiments explicitly contemplated by the present disclosure.

Example 1. A method implemented in one or more servers, the method comprising: sending, to a user device executing a software application, a tagging snippet to be provided in the software application along with a content software application requested from a content provider and auxiliary content the software application received from an auxiliary content provider; wherein the tagging snippet, in response to a user interacting with the auxiliary content via the software application, causes the software application to (i) obtain a public key, (ii) encrypt, using the public key, personally identifiable information (PII) associated with the user, and (iii) send the encrypted PII to a collection endpoint associated with a trusted execution environment (TEE) implemented in a cloud computing platform.

Example 2. The method of example 1, wherein the tagging snippet causes the software application to obtain the public key from a third-party coordinator operating independently of the cloud computing platform and of the auxiliary content provider.

Example 3. The method of example 1, wherein the tagging snippet causes the software application to obtain the public key from the auxiliary content provider

Example 4. The method of any one of the preceding examples, wherein the auxiliary content includes an advertisement.

Example 5. The method of any one of the preceding examples, wherein software application is a web browser.

Example 6. The method of any one of the preceding examples, wherein the tagging snippet is a server-side tagging snippet.

Example 7. The method of any one of the preceding examples, wherein the tagging snippet is a client-side tagging snippet.

Example 8. A method implemented in a plurality of servers, the method comprising: receiving, at a cloud staging layer implemented in a cluster manager, encrypted personally identifiable information (PII) for a plurality of users; transmitting, to a trusted execution environment (TEE) via a collection endpoint in a cloud computing platform, the encrypted PII; decrypting, within the TEE, the encrypted PII using a private key; and processing, within the TEE, the decrypted PII.

Example 9. The method of example 8, further comprising: obtaining a first portion of the private key from a primary coordinator; and obtaining a second portion of the private key from a secondary coordinator operating independently of the primary coordinator.

Example 10. The method of example 8, further comprising: obtaining the private key from an external key manager.

Example 11. The method of example 10, wherein the private key is associated with a client from which the encrypted PII was received.

Example 12. The method of any one of examples 8-11, wherein the transmitting of the encrypted PII to the TEE via the collection endpoint includes making a synchronous request.

Example 13. The method of any one of examples 8-11, wherein: the transmitting of the encrypted PII to the TEE via the collection endpoint includes making a synchronous request, including: uploading a set of the encrypted PII to the cloud computing platform, and submitting a request to a load balancer in the cloud computing platform to initiate processing.

Example 14. The method of any one of examples 8-12, wherein the processing of the decrypted PII includes one or more of (i) confidential matching, (ii) attribution, or (iii) aggregation.

Example 15. The method of any one of examples 8-14, wherein the processing of the decrypted PII includes matching the PII to account IDs with which a plurality of users log into an online service.

Example 16. The method of example 15, further comprising: receiving, from a database associated with the online service, the account IDs.

Example 17. The method of any one of examples 8-14, wherein the processing of the decrypted PII includes matching the PII to click IDs associated with click events, wherein the click IDs are appended to requests to access websites with auxiliary content.

Example 18. The method of any one of examples 8-14, wherein the processing of the decrypted PII includes matching the PII to pseudo IDs that identify events generated for respective users.

Example 19. A cloud computing platform comprising a set of servers and configured to implement a method according to any one of examples 8-18.

Example 19. One or more servers comprising processing hardware and configured to implement a method of any one of examples 1-7.

The following additional considerations apply to the foregoing discussion.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A method implemented in one or more servers, the method comprising:
sending, to a user device executing a software application, a tagging snippet to be provided in the software application along with a content software application requested from a content provider and auxiliary content the software application received from an auxiliary content provider;
wherein the tagging snippet, in response to a user interacting with the auxiliary content via the software application, causes the software application to:
(i) obtain a public key,
(ii) encrypt, using the public key, personally identifiable information (PII) associated with the user, and
(iii) send the encrypted PII to a collection endpoint associated with a trusted execution environment (TEE) implemented in a cloud computing platform.

2. The method of claim 1, wherein the tagging snippet causes the software application to obtain the public key from a third-party coordinator operating independently of the cloud computing platform and of the auxiliary content provider.

3. The method of claim 1, wherein the tagging snippet causes the software application to obtain the public key from the auxiliary content provider.

4. The method of claim 1, wherein the auxiliary content includes an advertisement.

5. The method of claim 1, wherein software application is a web browser.

6. The method of claim 1, wherein the tagging snippet is a server-side tagging snippet.

7. The method of claim 1, wherein the tagging snippet is a client-side tagging snippet.

8. A method implemented in a plurality of servers, the method comprising:
receiving, at a cloud staging layer implemented in a cluster manager, encrypted personally identifiable information (PII) for a plurality of users;
transmitting, to a trusted execution environment (TEE) via a collection endpoint in a cloud computing platform, the encrypted PII;
decrypting, within the TEE, the encrypted PII using a private key; and
processing, within the TEE, the decrypted PII.

9. The method of claim 8, further comprising:
obtaining a first portion of the private key from a primary coordinator; and
obtaining a second portion of the private key from a secondary coordinator operating independently of the primary coordinator.

10. The method of claim 8, further comprising:
obtaining the private key from an external key manager.

11. The method of claim 10, wherein the private key is associated with a client from which the encrypted PII was received.

12. The method of claim 8, wherein:
the transmitting of the encrypted PII to the TEE via the collection endpoint includes making a synchronous request

13. The method of claim 8, wherein:
the transmitting of the encrypted PII to the TEE via the collection endpoint includes making a synchronous request, including:
uploading a set of the encrypted PII to the cloud computing platform, and
submitting a request to a load balancer in the cloud computing platform to initiate processing.

14. The method of claim 8, wherein the processing of the decrypted PII includes one or more of (i) confidential matching, (ii) attribution, or (iii) aggregation.

15. The method of claim 8, wherein the processing of the decrypted PII includes matching the PII to account IDs with which a plurality of users log into an online service.

16. The method of claim 15, further comprising:
receiving, from a database associated with the online service, the account IDs.

17. The method of claim 8, wherein the processing of the decrypted PII includes matching the PII to click IDs associated with click events, wherein the click IDs are appended to requests to access websites with auxiliary content.

18. The method of claim 8, wherein the processing of the decrypted PII includes matching the PII to pseudo IDs that identify events generated for respective users.

19. A cloud computing platform comprising a set of servers and configured to:
receive, at a cloud staging layer implemented in a cluster manager, encrypted personally identifiable information (PII) for a plurality of users;
transmit, to a trusted execution environment (TEE) via a collection endpoint in a cloud computing platform, the encrypted PII;
decrypt, within the TEE, the encrypted PII using a private key; and
process, within the TEE, the decrypted PII.

20. The cloud computing platform of claim 19, further configured to:
obtain a first portion of the private key from a primary coordinator; and
obtain a second portion of the private key from a secondary coordinator operating independently of the primary coordinator.
